(19) United States
(12) Patent Application Publication
(10) Pub. No.: US 2015/0047445 A1
(43) Pub. Date: Feb. 19, 2015

(54) FINE ADJUSTMENT MECHANISM AND ANGLE ADJUSTING DEVICE HAVING THE FINE ADJUSTMENT MECHANISM

(71) Applicant: Wistron NeWeb Corp., Hsinchu (TW)

(72) Inventors: Lan-Chun Yang, Hsinchu County (TW); Ming-Chan Lee, Hsinchu County (TW); Yi-Chieh Lin, Hsinchu County (TW); Hung-Yuan Lin, Hsinchu County (TW); San-Yi Kuo, Hsinchu County (TW)

(73) Assignee: Wistron NeWeb Corp., Hsinchu (TW)

(21) Appl. No.: 14/156,357

(22) Filed: Jan. 15, 2014

(30) Foreign Application Priority Data
Aug. 19, 2013 (TW) 102215549

(51) Int. Cl. F16H 25/20

(52) U.S. Cl. CPC F16H 25/20
USPC 74/89.39

(57) ABSTRACT

A fine adjustment mechanism includes a connecting unit and a fine-tuning bolt having a bolt shaft and a bolt head. The bolt shaft has a threaded section rotatably engaged with the connecting unit, a non-threaded section between the threaded section and the bolt head, and an annular protrusion projecting outwardly and radially from an outer surface of the non-threaded section and spaced apart from the bolt head. A retaining unit is molded over the fine-tuning bolt and covers the annular protrusion and portions of the non-threaded section which are proximate to two opposite annular end surfaces of the annular protrusion. The fine-tuning bolt is rotatable relative to the retaining unit. The connecting unit is movable along the threaded section when the fine-tuning bolt is rotated.

### CROSS-REFERENCE TO RELATED APPLICATION

This application claims priority of Taiwanese Patent Application No. 102215549, filed on Aug. 19, 2013, the disclosure of which is incorporated herein by reference.

### BACKGROUND OF THE INVENTION

1. Field of the Invention

This invention relates to a fine adjustment mechanism, more particularly to a fine adjustment mechanism that is used for fine-tuning the angle of a satellite antenna and an angle adjusting device having the fine adjustment mechanism.

2. Description of the Related Art

Referring to FIGS. 1 and 2, a currently existing angle adjusting device 100 for adjusting the angle of a satellite antenna includes two fine adjustment mechanisms 1 (only one is shown in FIG. 1) for fine-tuning the elevation angle and the azimuth angle of the satellite antenna, respectively. Each fine adjustment mechanism 1 includes a retaining body 11, a locking bolt 12, a fine-tuning bolt 13, a graduated disc 14, a cap 15, a nut 16 and a connecting unit 17.

Referring to FIGS. 3 and 4, in combination with FIG. 2, the retaining body 11 includes a base wall 111, and a surrounding wall 112 extending upwardly from an outer periphery of the base wall 111. The base wall 111 is formed with a through hole 113. The base wall 111 and the surrounding wall 112 cooperatively define a receiving space 114 that communicates with the through hole 113. The locking bolt 12 includes a threaded rod 121 extending through the through hole 113 for threaded connection with the nut 16, and a limiting piece 122 formed at one end of the threaded rod 121 and received in the receiving space 114. The fine-tuning bolt 13 includes a bolt shaft 131 threadedly connected to the connecting unit 17, a bolt head 132 formed at one end of the bolt shaft 131, and an annular protrusion 133 projecting outwardly and radially from an outer surface of the bolt shaft 131. The graduated disc 14 is sleeved on the bolt shaft 131 between the annular protrusion 133 and the bolt head 132. The cap 15 includes a cap body 151, and two flexible snaps 152 projecting from two opposite sides of the cap body 151. The cap body 151 is formed with a limiting groove 153 to receive the annular protrusion 133, and two shaft grooves 154 at two opposite sides of and communicating with the limiting groove 153 to receive portions of the bolt shaft 131 which are proximate to two opposite annular end surfaces of the annular protrusion 133. The two flexible snaps 152 are respectively received in two retaining grooves 115 of the surrounding wall 112. Each flexible snap 152 has an engaging surface 155 engaged to a wall 116 that defines a respective retaining groove 115.

To assemble the locking bolt 12, the fine-tuning bolt 13 and the cap 15 to the retaining body 11, the locking bolt 12 is first disposed in the receiving space 114 such that the threaded rod 121 extends through the through hole 113 and the limiting piece 122 abuts against the base wall 111. Next, the graduated disc 14 is sleeved on the bolt shaft 131 between the annular protrusion 133 and the bolt head 132. Afterwards, the bolt shaft 131 of the fine-tuning bolt 13 is extended through the receiving space 114 and two notches 117 of the surrounding wall 112 such that a portion of the annular protrusion 133 is retained in a limiting recess 123 of the limiting piece 122. Finally, the two flexible snaps 152 of the cap 15 are inserted into the respective retaining grooves 115 of the retaining body 11, and the engaging surface 155 of each flexible snap 152 is engaged with the wall 116 that defines the respective retaining groove 115, thereby positioning the cap body 151 on a portion of the fine-tuning bolt 13 that is proximate to the bolt head 132. At this time, another opposite portion of the annular protrusion 133 is retained in the limiting groove 153, and portions of the bolt shaft 131 that are at two opposite sides of the annular protrusion 133 are retained in the shaft grooves 154.

Because the aforesaid fine adjustment mechanism 1 has numerous components, many steps are involved and many working hours are consumed during assembly thereof. This leads to high manufacturing costs of the fine adjustment mechanism 1. Further, because an assembly tolerance exists between the locking bolt 12 and the retaining body 11, between the fine-tuning bolt 13 and the retaining body 11, between the fine-tuning bolt 13 and the locking bolt 12, between the cap 15 and the fine-tuning bolt 13, and between the cap 15 and the retaining body 11, the assembly tolerance must be considered during design and manufacture of the aforesaid components, so that the design and the manufacture of the aforesaid components are complicated. Moreover, because of the presence of the aforesaid assembly tolerances among the components, each flexible snap 152 of the cap 15 cannot be smoothly inserted into the respective retaining groove 115 so that the cap 15 cannot be mounted and positioned on the retaining body 11; or, although the flexible snaps 152 are inserted into the respective retaining grooves 115, the engaging surface 155 of each flexible snap 152 cannot tightly engage with the wall 116 that defines the respective retaining groove 115. As such, the locking bolt 12, the fine-tuning bolt 13 and the cap 15 may loosely move inside the retaining body 11. Due to the effect of the aforesaid factors, the defective rate of assembly among the retaining body 11, the locking bolt 12, the fine-tuning bolt 13 and the cap 15 is high.

### SUMMARY OF THE INVENTION

Therefore, an object of the present invention is to provide a fine adjustment mechanism that has a minimum number of components so as to reduce assembly time and manufacturing costs.

Another object of this invention is to provide a fine adjustment mechanism that has components which are simple in design, which are easy to manufacture, and which can be manufactured with a high yield rate.

According to one aspect of this invention, a fine adjustment mechanism comprises a connecting unit, a fine-tuning bolt, a graduated disc and a retaining unit. The fine-tuning bolt includes a bolt shaft, and a bolt head formed at one end of the bolt shaft. The bolt shaft has a threaded section rotatably engaged with the connecting unit, a non-threaded section between the threaded section and the bolt head, and an annular protrusion projecting outwardly and radially from an outer surface of the non-threaded section and spaced apart from the bolt head. The graduated disc is sleeved on the non-threaded section and is disposed between the bolt head and the annular protrusion. The retaining unit is molded over the fine-tuning bolt and covers the annular protrusion and portions of the non-threaded section which are proximate to two opposite annular end surfaces of the annular protrusion. The fine-tuning bolt is rotatable relative to the retaining unit. The connecting unit is movable along the threaded section when the fine-tuning bolt is rotated.

Still another object of this invention is to provide an angle adjusting device that has a fine adjustment mechanism. The fine adjustment mechanism has a minimum number of components so as to reduce assembly time and manufacturing costs.

Still yet another object of this invention is to provide an angle adjusting device that has a fine adjustment mechanism. Components of the fine adjustment mechanism are simple in design, are easy to manufacture, and can be manufactured with a high yield rate.

According to another aspect of this invention, an angle adjusting device comprises a support frame and a fine adjustment mechanism. The support frame includes two frame members connected pivotably to each other. The fine adjustment mechanism includes a connecting unit connected to one of the frame members, a fine-tuning bolt, a graduated disc and a retaining unit. The fine-tuning bolt includes a bolt shaft, and a bolt head formed at one end of the bolt shaft. The bolt shaft has a threaded section rotatably engaged with the connecting unit, a non-threaded section between the threaded section and the bolt head, and an annular protrusion projecting outwardly and radially from an outer surface of the non-threaded section and spaced apart from the bolt head. The graduated disc is sleeved on the non-threaded section and is disposed between the bolt head and the annular protrusion. The retaining unit is connected to the other one of the frame members and is molded over the fine-tuning bolt. The retaining unit covers the annular protrusion and portions of the non-threaded section which are proximate to two opposite annular end surfaces of the annular protrusion. The fine-tuning bolt is rotatable relative to the retaining unit. The connecting unit is movable along the threaded section when the fine-tuning bolt is rotated.

The advantage of this invention resides in that with the retaining body being molded over the fine-tuning bolt and the locking bolt, and with the retaining body covering the annular protrusion, the portions of the non-threaded section which are proximate to the respective annular end surfaces of the annular protrusion and a portion of the locking bolt, the retaining body can connect together the fine-tuning bolt and the locking bolt. As such, components of the retaining unit for retaining the fine-tuning bolt on the first frame member can be minimized, and the assembly time and the manufacturing costs associated therewith can be reduced. Moreover, because the retaining body is not affected by the assembly tolerance between the annular protrusion and the limiting recess during forming thereof, the cumulative tolerance existing among the components described in the prior art can be avoided. Hence, the design and manufacture of the retaining body, the fine-tuning bolt and the locking bolt are simpler and easier as compared to that of the aforesaid prior art. Further, the retaining body, the fine-tuning bolt and the locking bolt can be manufactured with a high yield rate.

### BRIEF DESCRIPTION OF THE DRAWINGS

Other features and advantages of the present invention will become apparent in the following detailed description of the embodiment of the invention, with reference to the accompanying drawings, in which:

FIG. 1 is a perspective view of a currently existing angle adjusting device;

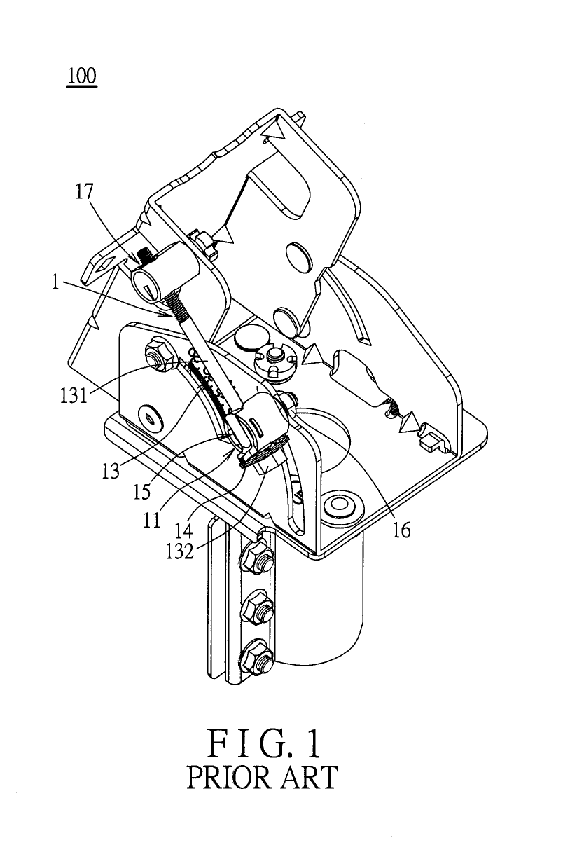

FIG. 2 is an exploded perspective view of a fine adjustment mechanism of the currently existing angle adjusting device;

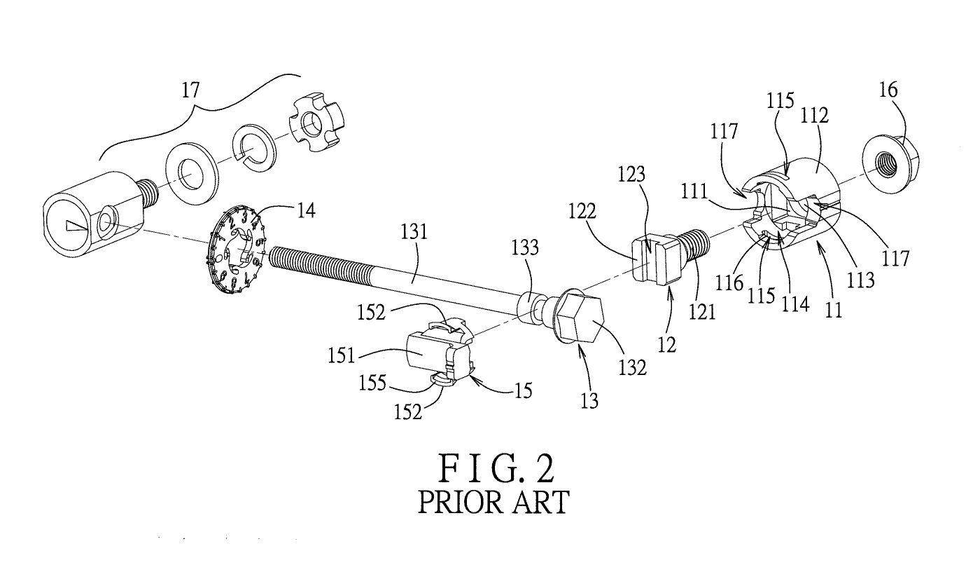

FIG. 3 is an assembled sectional view of the fine adjustment mechanism of FIG. 2;

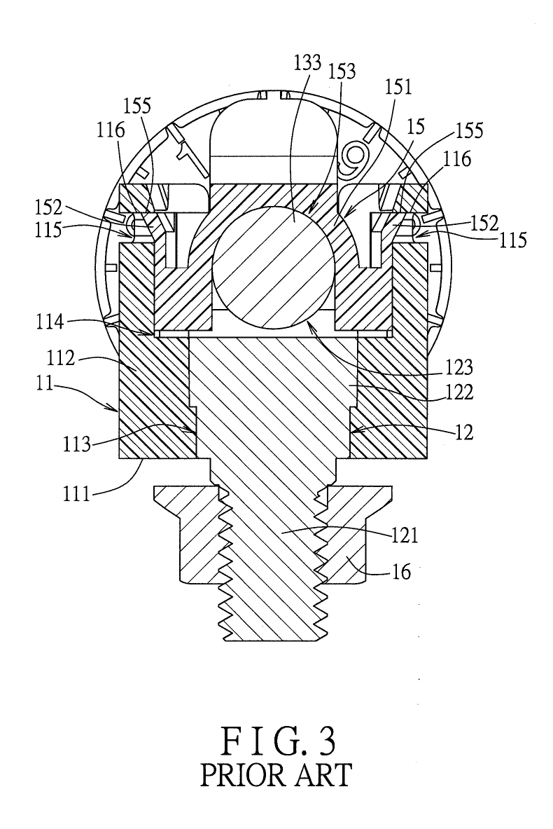

FIG. 4 is another assembled sectional view of the fine adjustment mechanism of FIG. 2;

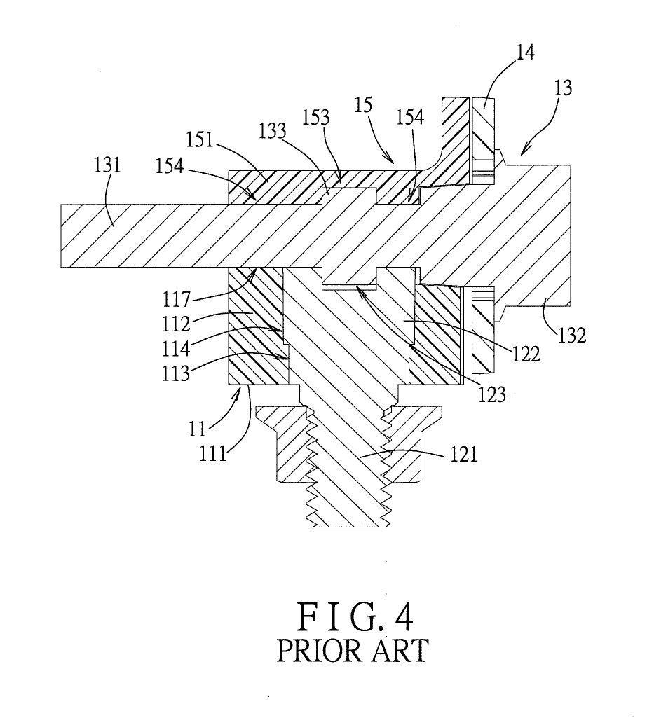

FIG. 5 is a perspective view of an angle adjusting device according to the embodiment of the present invention;

FIG. 6 is a perspective view of the angle adjusting device of this embodiment taken from another angle;

FIG. 7 is an exploded perspective view of a fine adjustment mechanism of the angle adjusting device of this embodiment;

FIG. 8 is an exploded perspective view of a portion of the fine adjustment mechanism of the angle adjusting device of this embodiment;

FIG. 9 is an assembled sectional view of this embodiment taken along line I-I of FIG. 5;

FIG. 10 is an assembled perspective view of a portion of the fine adjustment mechanism of the angle adjusting device of this embodiment;

FIG. 11 is a view similar to FIG. 10, but illustrating a cap being molded over a fine-tuning bolt and a locking bolt; and

FIG. 12 is a sectional view of this embodiment taken along line II-II of FIG. 11.

### DETAILED DESCRIPTION OF THE PREFERRED EMBODIMENT

The above-mentioned and other technical contents, features, and effects of this invention will be clearly presented from the following detailed description of one embodiment in coordination with the reference drawings.

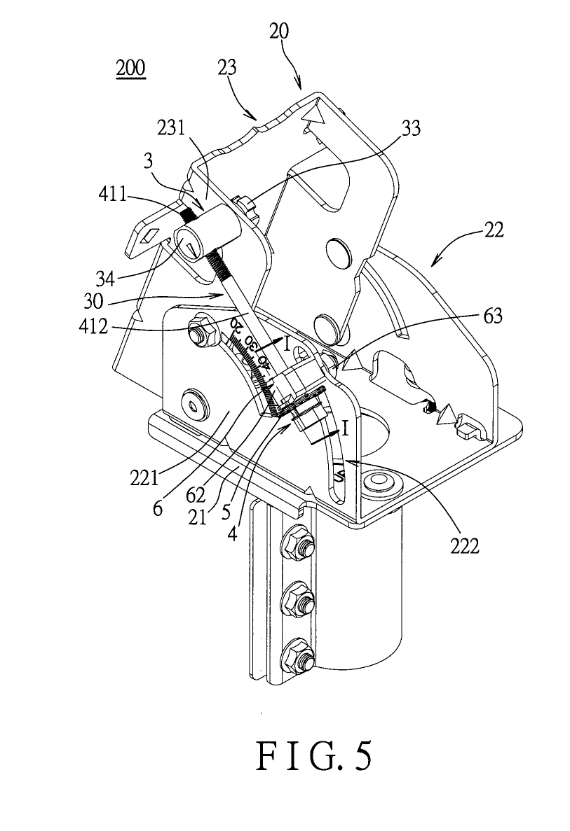

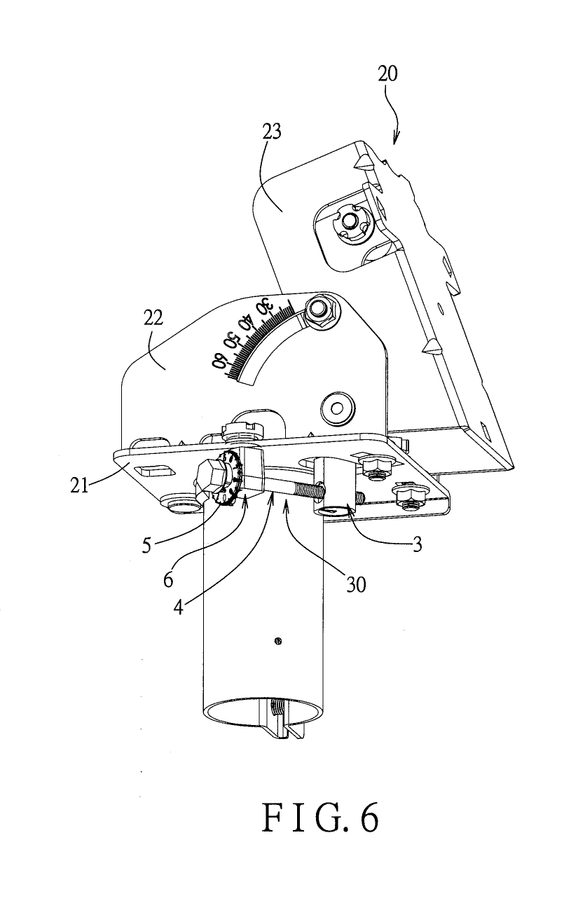

Referring to FIGS. 5 and 6, an angle adjusting device 200 according to the embodiment of this invention is used for fine-tuning the angle of a satellite antenna (not shown), and is shown to comprise a support frame 20 and two fine adjustment mechanisms 30.

The support frame 20 includes a base frame member 21, a first frame member 22 adjustably and pivotably connected to the base frame member 21, and a second frame member 23 adjustably and pivotably connected to the first frame member 22 and adapted to support the satellite antenna. One of the fine adjustment mechanisms 30 (see FIG. 6) is connected between the base frame member 21 and the first frame member 22 for fine-tuning the azimuth angle of the satellite antenna. The other fine adjustment mechanism 30 (see FIG. 5) is connected between the first and second frame members 22, 23 for fine-tuning the elevation angle of the satellite antenna. Because the structures of the two fine adjustment mechanisms 30 are similar, only the fine adjustment mechanism 30 that is connected between the first and second frame members 22, 23 will be described hereinafter as an example for illustration.

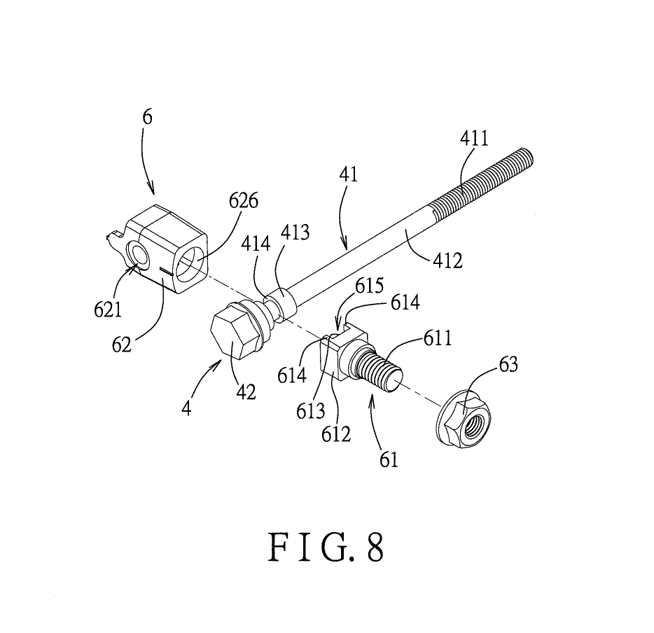

Referring to FIGS. 5, 7 and 8, the fine adjustment mechanism 30 includes a connecting unit 3, a fine-tuning bolt 4, a graduated disc 5, and a retaining unit 6. The connecting unit 3 includes a tubular body 31, two gaskets 32, a nut 33 and a connector 34. The tubular body 31 has a threaded rod section 311 projecting outwardly from one end of the tubular body 31 and extending through a hole (not visible in FIG. 5) in a side plate 231 of the second frame member 23 so as to abut the tubular body 31 against an outer surface of the side plate 231. The gaskets 32 are sleeved on the threaded rod section 311 and are located on an inner side of the side plate 231. The nut 33 is threadedly connected to the threaded rod section 311, and tightly presses the gaskets 32 against an inner surface of the side plate 231, so that the connecting unit 3 can be positioned on the side plate 231. The tubular body 31 further has a receiving groove 313, and two opposite through holes 314 communicating with the receiving groove 313 for extension of the fine-tuning bolt 4 therethrough. The connector 34 is inserted into the receiving groove 313, and is formed with a threaded hole 341 corresponding in position to the through holes 314 for threaded engagement with the fine-tuning bolt 4.

The fine-tuning bolt 4 includes a bolt shaft 41, and a bolt head 42 formed at one end of the bolt shaft 41. The bolt shaft 41 has a threaded section 411 rotatably connected with the connecting unit 3, a non-threaded section 412 between the threaded section 411 and the bolt head 42, and an annular protrusion 413 projecting outwardly and radially from an outer surface of the non-threaded section 412 and spaced apart from the bolt head 42. The threaded section 411 is inserted into one of the through holes 314, rotatably engages the threaded hole 341, and extends out of the other through hole 314. The graduated disc 5 is sleeved on the non-threaded section 412, and is located at a position spaced apart from and disposed between the bolt head 42 and the annular protrusion 413.

The retaining unit 6 is connected to and positioned on a side plate 221 of the first frame member 22. The retaining unit 6 is molded over the fine-tuning bolt 4, and covers the annular protrusion 413 and portions of the non-threaded section 412 which are respectively proximate to two opposite annular end surfaces 414 of the annular protrusion 413. Through this, components of the retaining unit 6 for retaining the fine-tuning bolt 4 on the first frame member 22 can be minimized, and the assembly time and the manufacturing costs associated therewith can be effectively reduced. Further, the fine-tuning bolt 4 is rotatable relative to the retaining unit 6, and can drive the connecting unit 3 to move axially along the threaded section 411 of the bolt shaft 41 when rotated so as to fine-tune the angle of the second frame member 23 relative to the first frame member 22.

A concrete structure and an assembly method of the retaining unit 6 will be described in detail below.

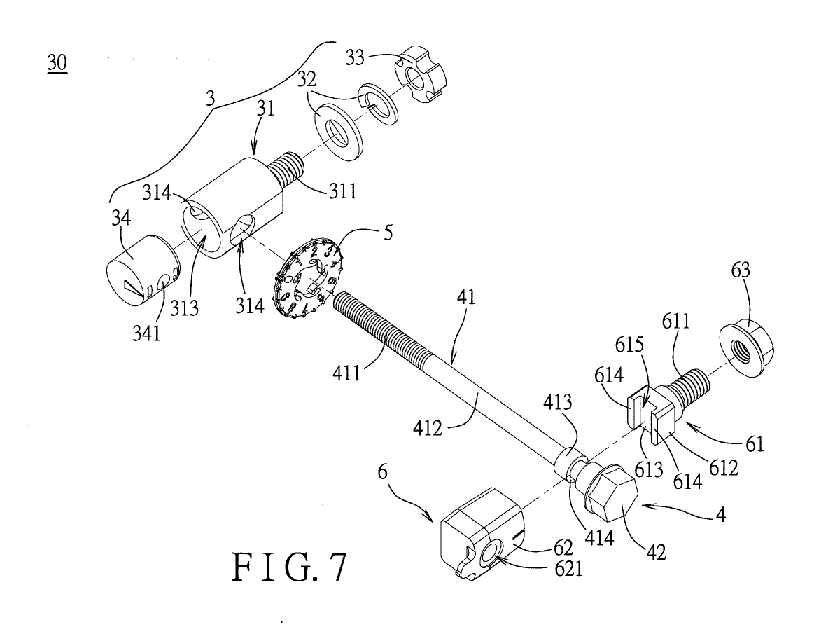

As shown in FIGS. 7 to 9, in this embodiment, the retaining unit 6 includes a locking bolt 61, a retaining body 62 and a nut 63. The retaining body 62 is made of plastic, and is formed on the fine-tuning bolt 4 and the locking bolt 61 by insert molding. The retaining body 62 covers the annular protrusion 413, the portions of the non-threaded section 412 which are respectively proximate to the two opposite annular end surfaces 414 of the annular protrusion 413, and a portion of the locking bolt 61, so that the retaining body 62 can connect together the fine-tuning bolt 4 and the locking bolt 61. Through this, the components of the retaining unit 6 for retaining the fine-tuning bolt 4 on the first frame member 22 can be minimized, and the assembly time and the manufacturing costs associated therewith can be reduced. Another portion of the locking bolt 61 that is exposed from the retaining body 62 is extended through a slide hole 222 of the side plate 221 and is threadedly engaged with the nut 63 so as to connect and position the retaining unit 6 to the side plate 221. Because the locking bolt 61 and the nut 63 are made of metal, they have a strong structure and can withstand a great force. Thus, the locking bolt 61 and the nut 63 can be stably connected and positioned to the side plate 221 to prevent breakage of the locking bolt 61.

Concretely speaking, the locking bolt 61 has a threaded rod 611, and a limiting piece 612 formed at one end of the threaded rod 611. The limiting piece 612 includes an end surface 613 opposite to the threaded rod 611, and two spaced-apart protruding portions 614 protruding from two opposite ends of the end surface 613. The protruding portions 614 and the end surface 613 cooperatively define a limiting recess 615 for receiving the annular protrusion 413.

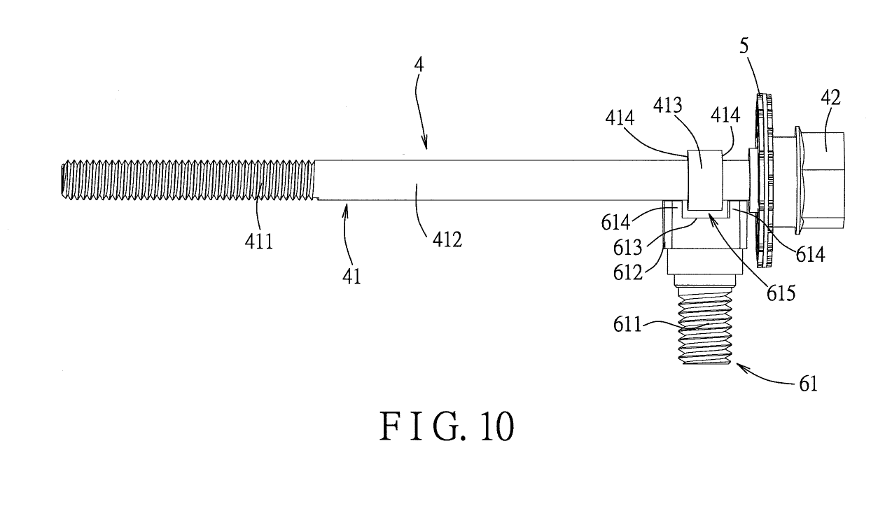

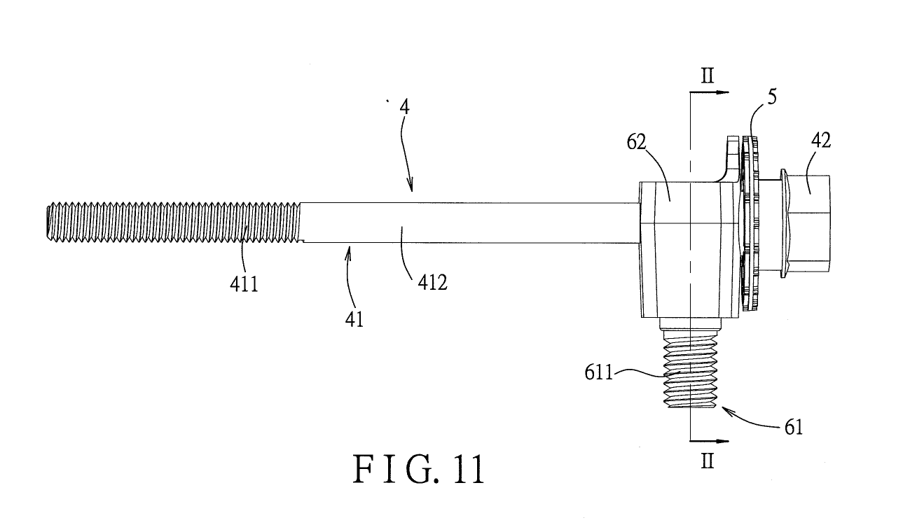

Referring to FIGS. 10 and 11, in combination with FIG. 7, to assemble together the retaining unit 6 and the fine-tuning bolt 4, the graduated disc 5 is first sleeved on the non-threaded section 412 of the fine-tuning bolt 4 and is disposed in proximity to the bolt head 42. Then, the annular protrusion 413 of the fine-tuning bolt 4 is brought to align with and is inserted into the limiting recess 615 such that the protruding portions 614 of the limiting piece 612 abut against the non-threaded section 412 of the fine-tuning bolt 4. In this embodiment, a clearance fit is formed between the annular protrusion 413 and the limiting recess 615, and the end surface 613 of the limiting piece 612 and the protruding portions 614 are spaced apart from the annular protrusion 413.

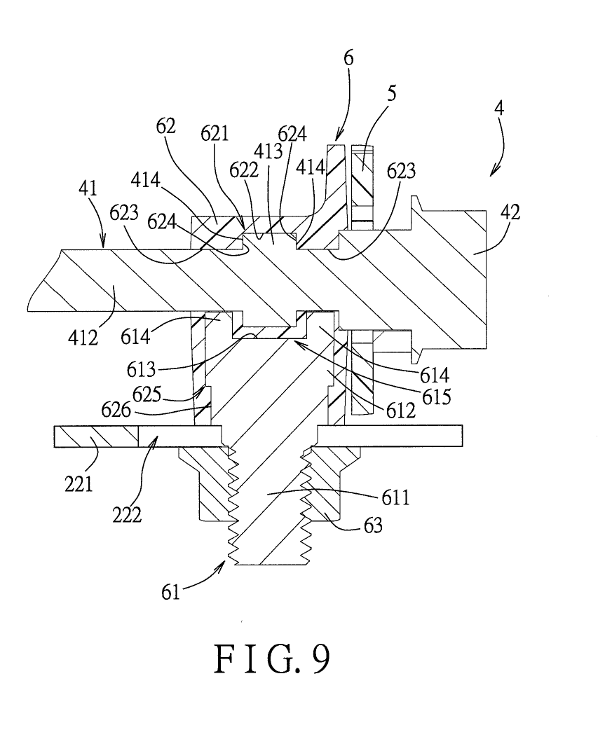

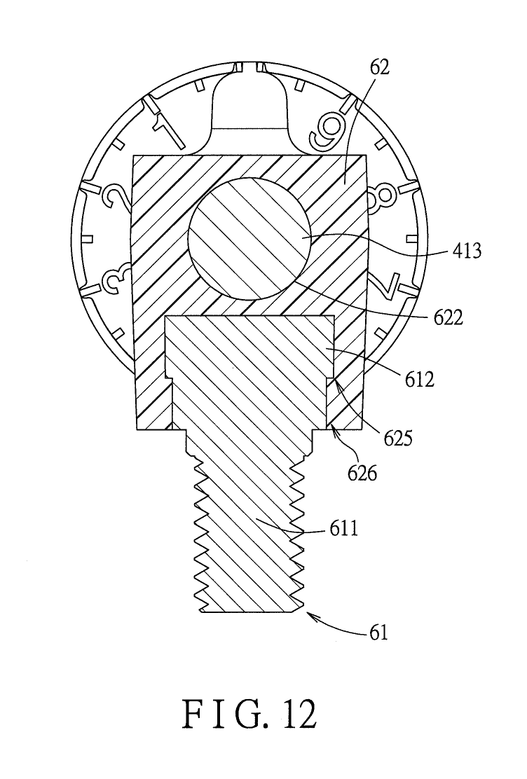

Referring to FIG. 12, in combination with FIGS. 9 and 11, the fine-tuning bolt 4, the graduated disc 5 and the locking bolt 61 are placed in a cavity (not shown) of a mold at the same time, after which molten plastic is injected into the mold cavity so that the molten plastic gradually fills the mold cavity and surrounds the locking bolt 61 and the fine-tuning bolt 4. Because a clearance fit is formed between the annular protrusion 413 and the limiting recess 615, and because the end surface 613 of the limiting piece 612 and the protruding portions 614 are spaced apart from the annular protrusion 413, the molten plastic will flow into the limiting recess 615 and fill up a space between the end surface 613 and the annular protrusion 413 and a space between each protruding portion 614 and the annular protrusion 413.

When the molten plastic fills up the mold cavity and is solidified, a retaining body 62 that is molded over the bolt shaft 41 of the fine-tuning bolt 4 and the locking bolt 61 is formed. At this time, the retaining body 62 covers the annular protrusion 413, the portions of the non-threaded section 412 which are respectively proximate to the two annular end surfaces 414 of the annular protrusion 413, the limiting piece 612 and a portion of the threaded rod 611. Thus, the retaining body 62 connects together the fine-tuning bolt 4 and the locking bolt 61.

The retaining body 62 is formed with a bolt hole 621 for rotatable connection of the fine-tuning bolt 4. The bolt hole 621 has a large diameter hole portion 622 for receiving the annular protrusion 413, two small diameter hole portions 623 communicating with and disposed at two opposite sides of the large diameter hole portion 622, and two stop shoulder portions 624 each formed between the large diameter hole portion 622 and a corresponding one of the small diameter hole portions 623. The large diameter hole portion 622 and the annular protrusion 413 are received in the limiting recess 615 of the limiting piece 614. The small diameter hole portions 623 respectively receive the portions of the non-threaded section 412 of the fine-tuning bolt 4 which are proximate to the annular end surfaces 414 of the annular protrusion 413. The stop shoulder portions 624 respectively abut against the annular end surfaces 414 of the annular protrusion 413. Each of the small diameter hole portions 623 has a diameter smaller than that of the large diameter hole portion 622. Because the two stop shoulder portions 624 tightly abut against the respective annular end surfaces 414 of the annular protrusion 413 so that no gap is formed between each stop shoulder portion 624 and the respective annular end surface 414 of the annular protrusion 413, the fine-tuning bolt 4 is prevented from rocking axially relative to the retaining body 62 during rotation of the fine-tuning bolt 4 relative to the connector 34 (see FIG. 7). Moreover, the retaining body 62 is further formed with a receiving space 625 for receiving the limiting piece 612, and an end hole 626 communicating with the receiving space 625 for extension of the threaded rod 611 therethrough. The threaded rod 611 is extended through the slide hole 222 of the side plate 221 such that the retaining body 62 abuts against the outer surface of the side plate 221, and the nut 63 is threadedly engaged to the threaded rod 611 and presses against the inner surface of the side plate 221. As such, the retaining unit 6 can be connected and positioned on the side plate 221.

Because of the flow characteristics of the molten plastic, whether the space between the end surface 613 and the annular protrusion 413 and the space between each protruding portion 614 and the annular protrusion 413 are large or small, the molten plastic can flow into the limiting recess 615 so as to fill the aforesaid spaces, and tightly covers the fine-tuning bolt 4 and the locking bolt 61, so that after the retaining body 62 is formed, the fine-tuning bolt 4 and the locking bolt 61 are stably connected and positioned on the retaining body 62. Since the retaining body 62 is not affected by an assembly tolerance between the annular protrusion 413 and the limiting recess 615 during forming thereof, design and manufacture of the retaining body 62, the fine-tuning bolt 4 and the locking bolt 61 are simple and easy. Further, the retaining body 62, the fine-tuning bolt 4 and the locking bolt 61 can be manufactured with a high yield rate.

It should be noted that the locking bolt 61 and the retaining body 62 of the retaining unit 6 of this embodiment are exemplified as two different materials, in actual application, molten plastic or molten metal may be used according to the requirement to form the retaining unit 6 having the retaining body 62 and the locking bolt 61 simultaneously, so that the single retaining unit 6 not only has the function of retaining the fine-tuning bolt 4 on the first frame member 22, but also simultaneously has the function of threaded connection with the nut 63.

In summary, with the retaining body 62 being molded over the fine-tuning bolt 4 and the locking bolt 61, and with the retaining body 62 covering the annular protrusion 413, the portions of the non-threaded section 412 which are proximate to the respective annular end surfaces 414 of the annular protrusion 413 and a portion of the locking bolt 61, the retaining body 62 can connect together the fine-tuning bolt 4 and the locking bolt 61. As such, components of the retaining unit 6 for retaining the fine-tuning bolt 4 on the first frame member 22 can be minimized, and the assembly time and the manufacturing costs associated therewith can be reduced. Moreover, because the retaining body 62 is not affected by the assembly tolerance between the annular protrusion 413 and the limiting recess 615 during forming thereof, the cumulative tolerance existing among the components described in the prior art can be avoided. Hence, the design and manufacture of the retaining body 62, the fine-tuning bolt 4 and the locking bolt 61 are simpler and easier as compared to that of the aforesaid prior art. Further, the retaining body 62, the fine-tuning bolt 4 and the locking bolt 61 can be manufactured with a high yield rate. Therefore, the objects of the present invention can be realized.

While the present invention has been described in connection with what is considered the most practical and embodiment, it is understood that this invention is not limited to the disclosed embodiment but is intended to cover various arrangements included within the spirit and scope of the broadest interpretations and equivalent arrangements.

What is claimed is:

1. A fine adjustment mechanism, comprising:
a connecting unit;
a fine-tuning bolt including a bolt shaft, and a bolt head formed at one end of said bolt shaft, said bolt shaft having a threaded section rotatably engaged with said connecting unit, a non-threaded section between said threaded section and said bolt head, and an annular protrusion projecting outwardly and radially from an outer surface of said non-threaded section and spaced apart from said bolt head;
a graduated disc sleeved on said non-threaded section and disposed between said bolt head and said annular protrusion; and
a retaining unit molded over said fine-tuning bolt and covering said annular protrusion and portions of said non-threaded section which are proximate to two opposite annular end surfaces of said annular protrusion;
wherein said fine-tuning bolt is rotatable relative to said retaining unit; and
wherein said connecting unit is movable along said threaded section when said fine-tuning bolt is rotated.

2. The fine adjustment mechanism as claimed in claim 1, wherein said retaining unit includes a locking bolt, and a retaining body molded over said fine-tuning bolt and said locking bolt, said retaining body covering said annular protrusion, said portions of said non-threaded section which are respectively proximate to said annular end surfaces of said annular protrusion, and a portion of said locking bolt.

3. The fine adjustment mechanism as claimed in claim 2, wherein said locking bolt is made of metal, and said retaining body is made of plastic.

4. The fine adjustment mechanism as claimed in claim 3, wherein said retaining body is formed with a bolt hole for rotatable connection of said fine-tuning bolt, said bolt hole having a large diameter hole portion for receiving said annular protrusion, and two small diameter hole portions communicating with and disposed at two opposite sides of said large diameter hole portion for respectively receiving said portions of said non-threaded section which are proximate to said annular end surfaces of said annular protrusion, each of said small diameter hole portions having a diameter smaller than that of said large diameter hole portion.

5. The fine adjustment mechanism of claim 4, wherein said locking bolt has a threaded rod, and a limiting piece formed at one end of said threaded rod, said limiting piece having a limiting recess for receiving said large diameter hole portion and said annular protrusion, said portion of said locking bolt that is covered by said retaining body being said limiting piece and a part of said threaded rod that is proximate to said limiting piece.

6. The fine adjustment mechanism as claimed in claim 5, wherein said limiting piece further has an end surface opposite to said threaded rod, and two protruding portions protruding from two opposite ends of said end surface of said limiting piece, said end surface and said two protruding portions of said limiting piece cooperatively defining said limiting recess and being spaced apart from said annular protrusion.

7. The fine adjustment mechanism as claimed in claim 6, wherein said bolt hole further has two stop shoulder portions each formed between said large diameter hole portion and a corresponding one of said small diameter hole portions, said stop shoulder portions respectively abutting against said annular end surfaces of said annular protrusion.

8. The fine adjustment mechanism as claimed in claim 6, wherein said retaining body is further formed with a receiving space for receiving said limiting piece, and an end hole communicating with said receiving space for extension of said threaded rod therethrough.

9. The fine adjustment mechanism as claimed in claim 1, wherein said retaining body is formed with a bolt hole for rotatable connection of said fine-tuning bolt, said bolt hole having a large diameter hole portion for receiving said annular protrusion, and two small diameter hole portions communicating with and disposed at two opposite sides of said large diameter hole portion for respectively receiving said portions of said non-threaded section which are proximate to said annular end surfaces of said annular protrusion, each of said small diameter hole portion having a diameter smaller than that of said large diameter hole portion.

10. The fine adjustment mechanism as claimed in claim 9, wherein said bolt hole further has two stop shoulder portions each formed between said large diameter hole portion and a corresponding one of said small diameter hole portions, said stop shoulder portions respectively abutting against said annular end surfaces of said annular protrusion.

11. An angle adjusting device, comprising:
a support frame including two frame members connected pivotably to each other; and
a fine adjustment mechanism including
a connecting unit connected to one of said frame members,
a fine-tuning bolt including a bolt shaft, and a bolt head formed at one end of said bolt shaft, said bolt shaft having a threaded section rotatably engaged with said connecting unit, a non-threaded section between said threaded section and said bolt head, and an annular protrusion projecting outwardly and radially from an outer surface of said non-threaded section and spaced apart from said bolt head,
a graduated disc sleeved on said non-threaded section and disposed between said bolt head and said annular protrusion, and
a retaining unit connected to the other one of said frame members and molded over said fine-tuning bolt, said retaining unit covering said annular protrusion and portions of said non-threaded section which are proximate to two opposite annular end surfaces of said annular protrusion;
wherein said fine-tuning bolt is rotatable relative to said retaining unit; and
wherein said connecting unit is movable along said threaded section when said fine-tuning bolt is rotated.

12. The fine adjustment mechanism as claimed in claim 11, wherein said retaining unit includes a locking bolt connected to the other one of said frame members, and a retaining body molded over said fine-tuning bolt and said locking bolt, said retaining body covering said annular protrusion, said portions of said non-threaded section which are respectively proximate to said annular end surfaces of said annular protrusion, and a portion of said locking bolt.

13. The fine adjustment mechanism as claimed in claim 12, wherein said locking bolt is made of metal, and said retaining body is made of plastic.

14. The fine adjustment mechanism as claimed in claim 13, wherein said retaining body is formed with a bolt hole for rotatable connection of said fine-tuning bolt, said bolt hole having a large diameter hole portion for receiving said annular protrusion, and two small diameter hole portions communicating with and disposed at two opposite sides of said large diameter hole portion for respectively receiving said portions of said non-threaded section which are proximate to said annular end surfaces of said annular protrusion, each of said small diameter hole portions having a diameter smaller than that of said large diameter hole portion.

15. The fine adjustment mechanism of claim 14, wherein said locking bolt has a threaded rod, and a limiting piece formed at one end of said threaded rod, said limiting piece having a limiting recess for receiving said large diameter hole portion and said annular protrusion, said portion of said locking bolt that is covered by said retaining body being said limiting piece and a part of said threaded rod that is proximate to said limiting piece.

16. The fine adjustment mechanism as claimed in claim 15, wherein said limiting piece further has an end surface opposite to said threaded rod, and two protruding portions protruding from two opposite ends of said end surface of said limiting piece, said end surface and said two protruding portions of said limiting piece cooperatively defining said limiting recess and being spaced apart from said annular protrusion.

17. The fine adjustment mechanism as claimed in claim 16, wherein said bolt hole further has two stop shoulder portions each formed between said large diameter hole portion and a corresponding one of said small diameter hole portions, said stop shoulder portions respectively abutting against said annular end surfaces of said annular protrusion.

18. The fine adjustment mechanism as claimed in claim 16, wherein said retaining body is further formed with a receiving space for receiving said limiting piece, and an end hole communicating with said receiving space for extension of said threaded rod therethrough.

19. The fine adjustment mechanism as claimed in claim 11, wherein said retaining body is formed with a bolt hole for rotatable connection of said fine-tuning bolt, said bolt hole having a large diameter hole portion for receiving said annular protrusion, and two small diameter hole portions communicating with and disposed at two opposite sides of said large diameter hole portion for respectively receiving said portions of said non-threaded section which are proximate to said annular end surfaces of said annular protrusion, each of said small diameter hole portion having a diameter smaller than that of said large diameter hole portion.

20. The fine adjustment mechanism as claimed in claim 19, wherein said bolt hole further has two stop shoulder portions each formed between said large diameter hole portion and a corresponding one of said small diameter hole portions, said stop shoulder portions respectively abutting against said annular end surfaces of said annular protrusion.
